(19) United States
(12) Patent Application Publication
(10) Pub. No.: US 2009/0106943 A1
(43) Pub. Date: Apr. 30, 2009

(54) REMOVABLE POWER TOOL PIVOTING ARM BRACE

(76) Inventors: Ricky B. Seratt, (US); Eric Jones, (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 12/254,675

(22) Filed: Oct. 20, 2008

Related U.S. Application Data
(60) Provisional application No. 61/131,391, filed on Jun. 9, 2008.
(60) Provisional application No. 61/130,102, filed on May 29, 2008.
(60) Provisional application No. 61/123,737, filed on Apr. 11, 2008.
(60) Provisional application No. 61/068,681, filed on Mar. 10, 2008.
(60) Provisional application No. 61/068,683, filed on Mar. 10, 2008.
(60) Provisional application No. 60/982,715, filed on Oct. 25, 2007.

(51) Int. Cl. B25G 1/01

(52) U.S. Cl. 16/430

(57) ABSTRACT

The subject of this disclosure is a brace for a variety of power tools to assist a user in controlling the tool. The brace extends from the power tool, and engages the forearm of the user to offset the pivot moment about the users wrist due to the weight and length of the power tool. The brace is configured to pivot in the horizontal and/or vertical plane to increase the ease of use and comfort of the user and/or to reduce the length of the overall tool and brace for storage.

### RELATED APPLICATIONS

This application claims priority benefit of U.S. Provisional Applications Ser. Nos. 61/131,391, Filed Jun. 9, 2008, 61/130,102, Filed May 29, 2008, 61/123,737, filed Apr. 11, 2008, 61/068,681, filed Mar. 10, 2008, 61/068,683, filed Mar. 10, 2008, and 60/982,715 filed Oct. 10, 2007. Each and every one of the above listed provisional patents incorporated herein by reference.

### BACKGROUND OF THE DISCLOSURE

a) Field of the Disclosure

Many prior art power tools are designed to be held by a user while in operation, but due to their weight or configuration they are very awkward to use. Such examples include the portable saw of U.S. Pat. No. 2,228,664. These worm-drive-type saws are often very long and often heavy, resulting in substantial movement about the handle which in U.S. Pat. No. 2,228,664 is labeled at 110. Thus, a second handle is often provided, as shown as a knob in U.S. Pat. No. 2,228,664 or other embodiments such as a ring or longitudinal handle above the motor. While this assists a user in cutting boards close to the body, and where both hands can be utilized, it is deficient in other applications.

### SUMMARY OF THE DISCLOSURE

Disclosed herein are several embodiments of a forearm brace for a hand-held power tool. In one form, the forearm brace comprises: a support arm removably coupled to the power tool at a first end of the support arm, a forearm engagement surface disposed upon the second end of the support arm, and an attachment device for coupling the brace to a power tool.

The forearm brace is configured such that the weight of the forearm brace and power tool are supported by the user grasping the power tool handle, while the forearm engagement surface engages a user's forearm between the user's radiocarpal joint (wrist) and elbow such that rotation of the power tool in relation to the forearm of the user is substantially prohibited by upward force of the forearm engagement surface upon the user's forearm. To increase the usefulness, the support arm in one form is operatively configured to be removably coupled to the power tool by an attachment device which allows the support arm to pivot in relation to the power tool. This pivoting movement can be in a horizontal or vertical plane. The brace can also be configured to pivot about a transverse plane.

In one form, the attachment device is operatively configured to allow the support arm to pivot substantially at the first end of the support arm in a vertical plane in relation to the power tool. This attachment device may allow the support arm to pivot in a range 80° above and below the longitudinal axis of the power tool. Additionally, the forearm brace may include a spring mechanism operatively configured to rotate the support arm upward when pressure is not applied downward to the forearm engagement surface. This arrangement moves at least a portion of the forearm brace out of the way for storage or other uses of the tool when the forearm engagement surface is not supportive.

As previously mentioned, the attachment device may be configured to allow the support arm to pivot in a horizontal plane in relation to the power tool. This pivot may be provided substantially at the first end of the support arm. When the support arm is thus pivoted, the forearm engagement surface may not be properly aligned, thus it may be desired to configure the apparatus such that the forearm engagement surface is operatively configured to rotate in relation to the support arm.

To increase comfort and stability, the forearm engagement surface may further comprise a padded surface which is operatively configured to engage the user's forearm. This padded surface may comprise a gel pad, open cell foam, closed cell foam, fabric, or other material.

The forearm brace in one form is configured such that the attachment device comprises a quick release mechanism operatively configured to adjust the position of the forearm brace in relation to the power tool. In one form, the quick release mechanism is configured to adjust the tension required to rotate the forearm brace in relation to the power tool. Pressure can be released to allow the forearm brace to rotate in relation to the power tool, and then be re-engaged to fix the relative position.

In one form, the forearm brace is operatively configured to be coupled to the power tool in such a way as to require no modification to the power tool. This may be accomplished by clamping the attachment device to the power tool, in one form to the handle of the poser tool. In one form, the attachment device is operatively configured to couple to a handle portion of the power tool and not substantially interfere with use of the handle. In this way, the attachment device does not substantially interfere with normal operation of the power tool handle portion.

The overall length of the brace should be long enough to provide support, yet short enough to engage the forearm of the user and not interfere with operation and storage of the tool. In one range, the longitudinal length of the forearm brace is up to 13 inches from a tool engagement surface, to a longitudinally outward end.

To provide a quick and easy means for removing the longer portions of the brace from the tool while leaving the attachment device coupled to the power tool, the attachment device in one form comprises a keyway. This keyway is operatively configured to receive a portion of the support arm. As such, the support arm could have a correlating surface such as a stud or projection to sit within the keyway. To keep the support arm attached to the attachment device, the keyway in one form further comprises a locking keyway. This locking keyway may be operatively configured to maintain position of the support arm in relation to the attachment device while the apparatus is engaged.

While each of the elements disclosed may be formed of individual parts, they may also be formed as combined components. For example, the support arm, forearm engagement surface and/or attachment device may be formed as a unitary structure.

The forearm brace for a power tool may also be configured where a forearm engagement surface is fixedly and removably coupled to the power tool. In this embodiment, the forearm engagement surface is operatively configured to engage a user's forearm between the user's radiocarpal joint and elbow such that rotation of the power tool at the user's wrist is substantially prohibited by upward force of the forearm engagement surface upon the user's forearm as with the previously mentioned example. As previously disclosed, the forearm engagement surface may be configured to be removably coupled to the power tool by an attachment device. The attachment device in one form allows the support arm to pivot in relation to the power tool. To facilitate this embodiment, the attachment device may be fixedly and removably coupled to the power tool, and the forearm engagement surface fixedly and removably coupled to the attachment device. Alternatively, the forearm engagement surface and attachment device may be formed as a unitary structure.

### BRIEF DESCRIPTION OF THE DRAWINGS

FIG. 1 is a highly schematic environmental view of one embodiment of the disclosure, coupled to the handle of a hand held saw.

FIG. 1a is a highly schematic environmental view of one embodiment of the disclosure, coupled to the handle of a hand held saw and pivoted in a vertical plane to a storage position.

FIG. 2 is a perspective view of one embodiment of the disclosure.

FIG. 3 is an end view of one embodiment of a forearm attachment surface.

FIG. 4 is a plan view of a band in one form.

FIG. 5 is a plan view of a band in another form.

FIG. 6 is a perspective view of a support arm 426 in one form.

FIG. 7 is an end view of one embodiment of a forearm attachment surface.

FIG. 8 is a plan view of a forearm engagement surface in one form.

FIG. 9 is a perspective view of a support arm in one form.

FIG. 10 is a perspective view of the underside of a forearm engagement surface in one form.

FIG. 11 is a prior art cam-locking bolt in one form.

FIG. 12 is a side view of one embodiment of the disclosure.

FIG. 13 is a side view of the toggle as shown in FIG. 15.

FIG. 14 is a perspective view of an attachment device.

FIG. 15 is a plan view of the embodiment as shown in FIG. 12 interconnected with the attachment device as shown in FIG. 14.

FIG. 16 is a perspective view of one embodiment of the disclosure.

FIG. 17 is a perspective view of one embodiment of the disclosure adjacent a prior art tool handle.

FIG. 18 is a plan view of an attachment device in one form.

FIG. 19 is a side view of one embodiment of the disclosure as shown in FIG. 18.

FIG. 20 is a detail plan view of a portion of the attachment device of FIG. 18.

FIG. 21 is a cutaway view of the embodiment shown in FIG. 20.

FIG. 22 is a highly schematic environmental view of one embodiment of the disclosure, coupled to the handle of a hand held saw.

FIG. 23 is a cutaway, end view of one embodiment of the disclosure.

FIG. 24 is an end view of another embodiment of a forearm engagement surface.

### DETAILED DESCRIPTION OF THE EMBODIMENTS

Applicant has discovered through discovery and testing that a forearm brace extending out beyond the handle portion of power tools and designed to engage a user's forearm while they grasp the handle of the tool reduces movement about the handle as the tool is being used. This arrangement simultaneously keeps the power tool such as a saw substantially in line with a user's forearm. This arrangement also helps to prevent injury and damage as a result of kickback, as the tool is supported by a user's elbow and shoulder, which are inherently stronger than a user's wrist. Details of this invention, including various embodiments are described herein.

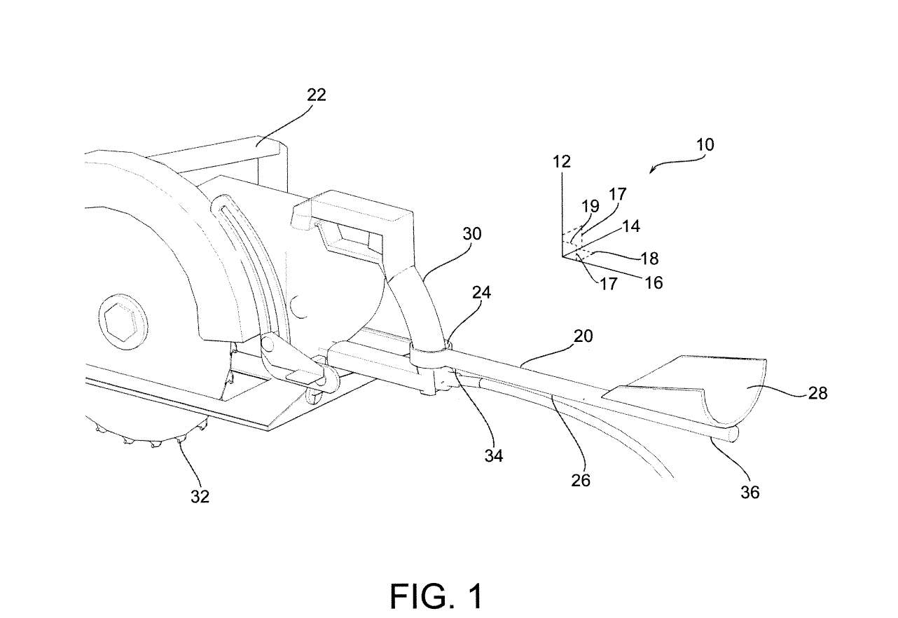

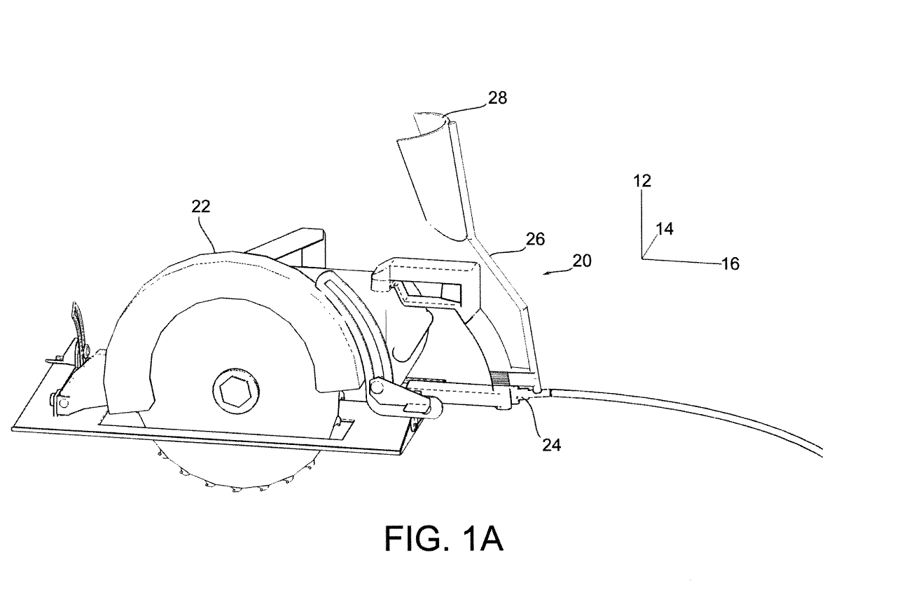

Before beginning, an axis system 10 is shown in FIG. 1, including a vertical axis 12, a transverse axis 14, and a longitudinal axis 16. These axis further describe a horizontal plane 18 defined by the transverse axis 14 and the longitudinal axis 16. These axes further describe a vertical plane 19 defined by the vertical axis 12 a longitudinal axis 16. These axis and planes are used for describing embodiments and are not intended to be limiting.

The forearm brace 20, as shown in a highly schematic view of FIG. 1, generally comprises three interoperating portions. The first portion is the attachment device 24 which is configured to attach to the power tool 22. In one form, the attachment device 24 can be attached to the power tool 22 without requiring any substantial or permanent modification to the power tool 22. This allows the forearm brace 20 to be positioned upon a variety of power tools. The second portion of the forearm brace 20 is the support arm 26 which extends longitudinally outward from the power tool 22 and is formed as part of, or coupled to, the attachment device 24. The third portion of forearm brace 20 is the forearm engagement surface 28 which is connected to the support arm 26 substantially at the opposite end from the power tool 22 and attachment device 24. The forearm engagement surface 28 may be a rigid device, which can extend transversely outward from one or both transverse sides of the support arm 26. This embodiment allows for the user to grasp the power tool handle 30 while the forearm of the user braces against the forearm engagement surface 28. In one form, the device extends longitudinally five to twelve inches from the tool. This allows the user's wrist to control the rotation of the power tool 22 around a longitudinal axis and allows the user's shoulder and elbow to control the angle of the power tool in the vertical and horizontal planes. As previously stated, these power tools 22 are often very heavy and this forearm brace allows the users wrist to be free from substantial force due to gravity and keeps the user's body away from the blade 32 or other dangerous surfaces of other power tools such as drills, routers, or power planes.

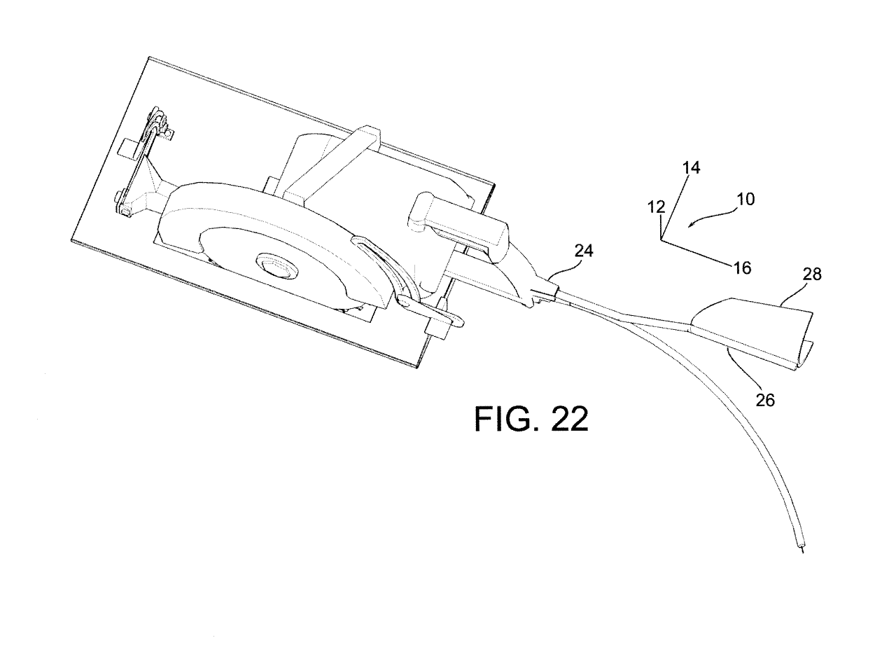

It is sometimes desired to be able to cut on a vertical surface such as a wall, or in an inverted horizontal surface such as a ceiling. Where it is possible to use both hands on the power tool simultaneously, such cuts pose little trouble. Where it is not possible to use both hands on the power tool simultaneously, the forearm brace in several embodiments is exemplary. The brace, or a portion thereof can be rotated as shown in FIG. 22 to allow for cutting of vertical surfaces as well as inverted horizontal surfaces if the forearm engagement surface 28 is rotated from the orientation shown in FIG. 1. While the forearm engagement surface of FIG. 22 is rotated approximately 90° from the embodiment shown in FIG. 1, other rotations are also possible in any increment. For example, for inverted horizontal cutting, the forearm engagement surface may be rotated 180°. This rotation can be accomplished by rotating the forearm engagement surface 28 around the support arm 26, or may also be accomplished by rotating the support arm 26 about the attachment device 24. Where the support arm 26 is non-linear, it may be desired to rotate both the forearm engagement surface 28 about the support arm 26, and rotate the support arm 26 about the attachment device 24.

### First Embodiment

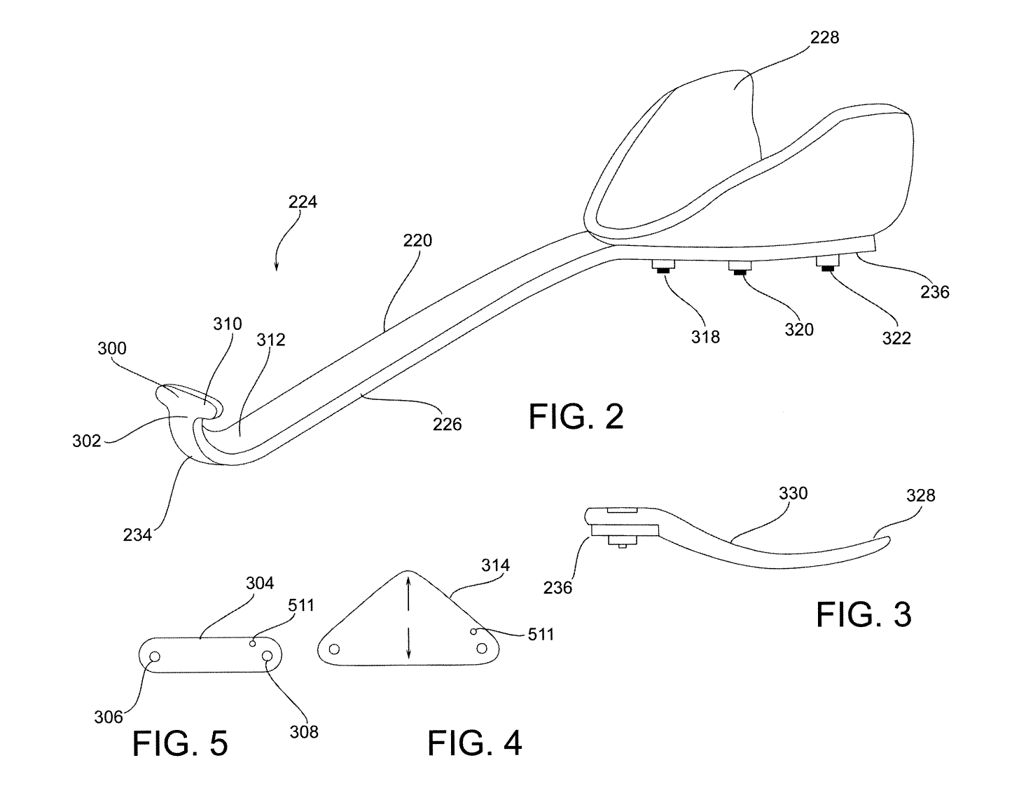

While separate elements from each embodiment can be interchanged, to best describe each element, individual composite embodiments will be shown. For example, the attachment device 224 of FIG. 2 could be coupled with the forearm engagement surface 28 of FIG. 1 without deviating from the scope of the disclosure.

Where ever possible similar numbering will be used. For example, the forearm brace 20 of FIG. 1 functions in a similar manner to the forearm brace 220 of FIG. 2.

The embodiment, shown in FIG. 2, substantially comprises the same operating portions as the highly schematic view of FIG. 1. These being an attachment device 224, a support arm 226, and a forearm engagement surface 228. The attachment device 224 generally comprises a tool engagement surface 300 which is configured to engage a surface on the power tool 22, such as the outer surface of the power tool handle 30. As can be seen, this tool engagement surface 300 in one form comprises a concave arc 302 which increases contact between the power tool handle 30 and the attachment device 224. This also allows the forearm brace 220 to be positioned at varying angles in the horizontal plane 18 in relation to the power tool 22. This allows for adjustability to suit the particular use of the tool and a user's preferences and comfort. For example, a right handed user may wish the power tool 22 to be rotated to the left of an in-line position similar to how a right-handed person often orients paper on a table when writing.

To maintain the attachment device 224 against the power tool 22, a variety of attachment means can be utilized. In one form, a band can be utilized, such as shown in FIGS. 4 and 5. The band 304 of FIG. 5 is configured to be wrapped around a portion of the power tool 22 and a portion of the first end 234 of the support arm 226. Then a fastener is fitted through the holes 306 and 308 and fastened in place. The quick release fastener 38, as shown in FIG. 11, functions very well to allow a user to quickly and easily release and reposition the forearm brace.

A ridge 310 may be provided on the top or back side 312 of the support arm 226 to keep the band 304 in a proper position relative to the support arm 226. These bands 304 and 314 can be manufactured from plastics, metals, or natural materials as long as they have sufficient tensile strength and rigidity to allow the tool engagement surface 300 to be sufficiently engaged against the power tool to enable the forearm brace 220. The bands 304 and 314 may be formed to fit the power tool or may have sufficient flexibility to do so once the fastener 38 is put in place and engaged.

The triangular band 314, as shown in FIG. 4, functions in the same way as the band 304 of FIG. 5 with the variation that the width 316 near the center of the triangular band 314 provides much more rotational support in the vertical plane 19 in comparison to the band 304 of FIG. 5. This may be useful for heavier tools, such as the saws and other tools often used in cutting wood, stone or concrete.

Returning to FIG. 2, it can be seen how the forearm engagement surface 228 in one form is substantially concave and generally conforms to the outer surface of a users forearm. This surface may be padded to allow for increased comfort to the user and may alternatively or additionally be comprised of a friction increasing surface such as neoprene rubber or the like to increase stability of the overall apparatus. In one form, a gel filled pad can be utilized to accomplish one or both of these desired outcomes.

As shown in FIG. 2, a plurality of fasteners can be used in one embodiment to affix the forearm engagement surface 228 to the second end 236 of the support arm 226. In this embodiment, a plurality of nuts and bolts are utilized although rivets, screws, adhesives could also be utilized. It is also conceived that the forearm engagement surface 228 be formed as a unitary structure with other aspects of the forearm brace 220. As shown, the fasteners include a forward attachment 318, a center attachment 320, and a rear attachment 322. It may be desired that one of the attachments, for example the center attachment 320, be provided in a substantially cylindrical hole to form a pivot, around which the forearm engagement surface 228 is allowed to rotate in relation to the support arm 226. As such, it may be desired that the hole or void through which the forward attachment 318 and rear attachment 322 is present is disposed, be arcuate in shape or comprised of a plurality of holes to allow for alternate positions of the forearm engagement surface 228 in relation to the forearm brace 220.

As shown in FIG. 2, the forearm engagement surface 228 is positioned in a vertical plane, substantially above the attachment device 224. In another embodiment, shown in FIG. 3, the forearm attachment surface 328 can be positioned alongside, and substantially in-line with the second end 236 of the support arm 226. As shown, the upper surface 330 of the forearm attachment surface 328 in one form remains substantially concave to conform to a users forearm. It may be desired in any of the embodiments to have the forearm engagement surface 328 to be formed of a material which can be molded to conform to a user's forearm.

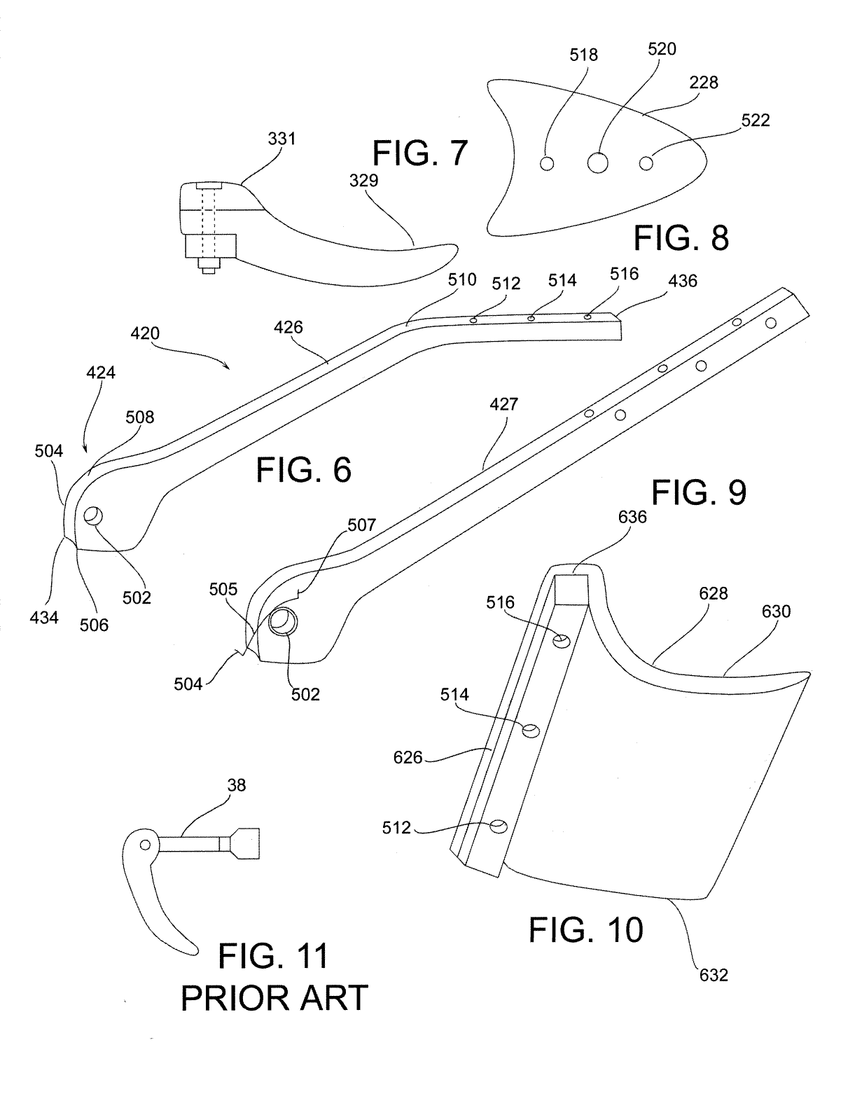

Another version offset forearm attachment surface 329 can be seen in FIG. 7. This embodiment includes a raised finger grip 331 which can be used to assist in pulling the forearm brace down from a raised, storage position, to a use position.

### Second Embodiment

The embodiment shown in FIG. 6 utilizes a slightly different support arm 426 than the previous embodiments. In this embodiment, the forearm brace 420 utilizes an attachment device 424 which allows for the forearm brace to rotate in a vertical plane around a pivot hole 502. In this embodiment, the bands 304 and 314, and similar devices can be used as previously discussed. However, the attachment mechanism, such as the quick release 38 of FIG. 11, passes through the holes 306 and 308 of the band as well as the pivot hole 502 of the support arm 426. It may be desired that the portion of the first end 434 of the support arm 426 which contacts the handle 30 of the power tool 22 comprises a concave surface 504 to increase the frictional coefficient therebetween and to increase rigidity and support.

The highly schematic view of FIG. 1a shows how the length of the overall assembly in the longitudinal direction 16 is substantially decreased when the forearm brace 20 is in the pivoted position. This also substantially puts the forearm brace out of a user's way for some uses.

As can be seen by looking at this embodiment, the concave surface 504 is not concentric in the vertical plane with the pivot hole 502. This allows the entire forearm brace 420 to pivot upward in the vertical plane to reduce the overall longitudinal length of the combination of the power tool and the forearm brace 420. When it is desired to utilize the forearm brace, it is rotated downward such that the concave surface 504 operates as a cam against the power tool 22. In other words, the concave surface 504 in one form comprises a surface 506 which is substantially more distant from the center of the pivot hole 502 than the surface 508 providing a cam-like action.

A spring mechanism 505 can be utilized such as for example a torsion spring which connects at a first end 507 to the forearm brace, around the attachment mechanism 38, and connects at a second end 509 to the power tool, or to a band 304 or equivalent device. A void 511 could be provided in the band 304 as shown in FIGS. 4 and 5 for this purpose. Of course elastic bands, compression springs, extension springs, or equivalent devices could also be utilized.

It may be desired in one form to have the support arm 426 be substantially non-linear by way of at least one bend 510 to increase in comfort and ease of use of the overall combination. Alternatively, a straight embodiment 427 may used as shown in FIG. 9, depending upon the user and the specific application. Also shown in the embodiment of FIG. 8 are a plurality of holes 512, 514, and 516 which are configured to interoperate with the attachments shown in FIG. 2 at 318, 320, and 322, respectively and previously explained. FIG. 8 shows a plan view of a forearm engagement surface 228 with a cooperating set of holes 518, 520, and 522 which line up respectively with the holes 512, 514, and 516 to allow passage of the fasteners 318, 320, and 322, respectively. Of course, other forearm engagement surfaces could be utilized, such as that as shown in FIG. 3, FIG. 10, or others.

FIG. 10 shows an embodiment of the forearm brace including an offset forearm attachment surface 628 configured such that the users forearm is positioned in a vertical plane substantially below the second end 636 of the support arm 626. In one embodiment, such as the forearm engagement surface of FIG. 3, may increase comfort and support to a user and may also be configured such that it can be reversed through the horizontal plane 18 to sit upon the opposite transverse side of the support arm 626 say, for example for a left handed user. In the embodiment shown in FIG. 10, the longitudinally outward end 630 has a deeper curvature than the longitudinally inward end 632. This increases comfort and support, and can be reversed for alternate uses. Alternatively, a plurality of mirror image devices may be provided for left-handed and right-handed users. In this arrangement, one will be configured to fit to the right transverse side of the support arm 26, and the other to the left transverse side of the support arm 26.

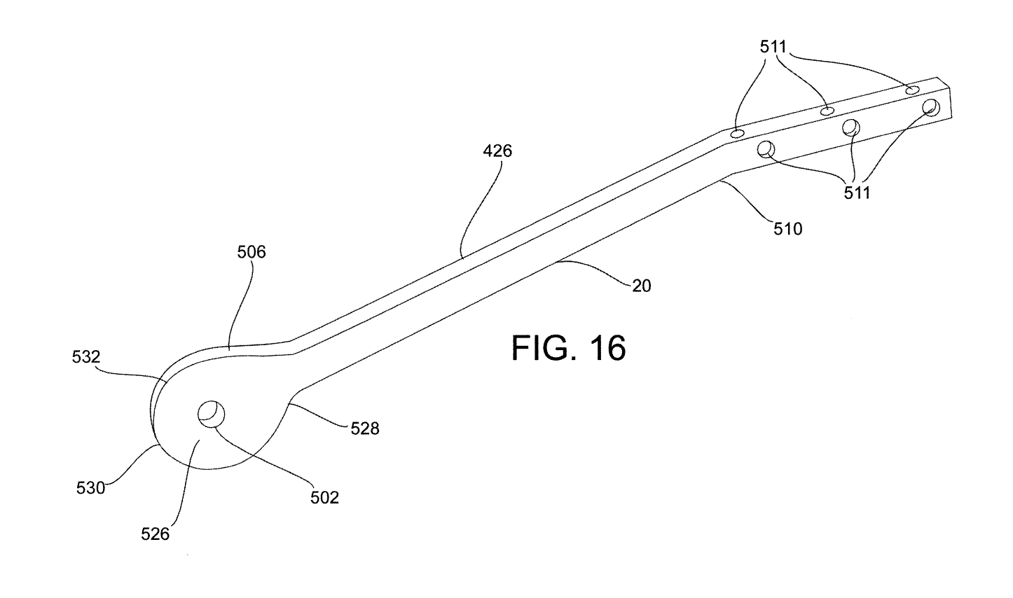

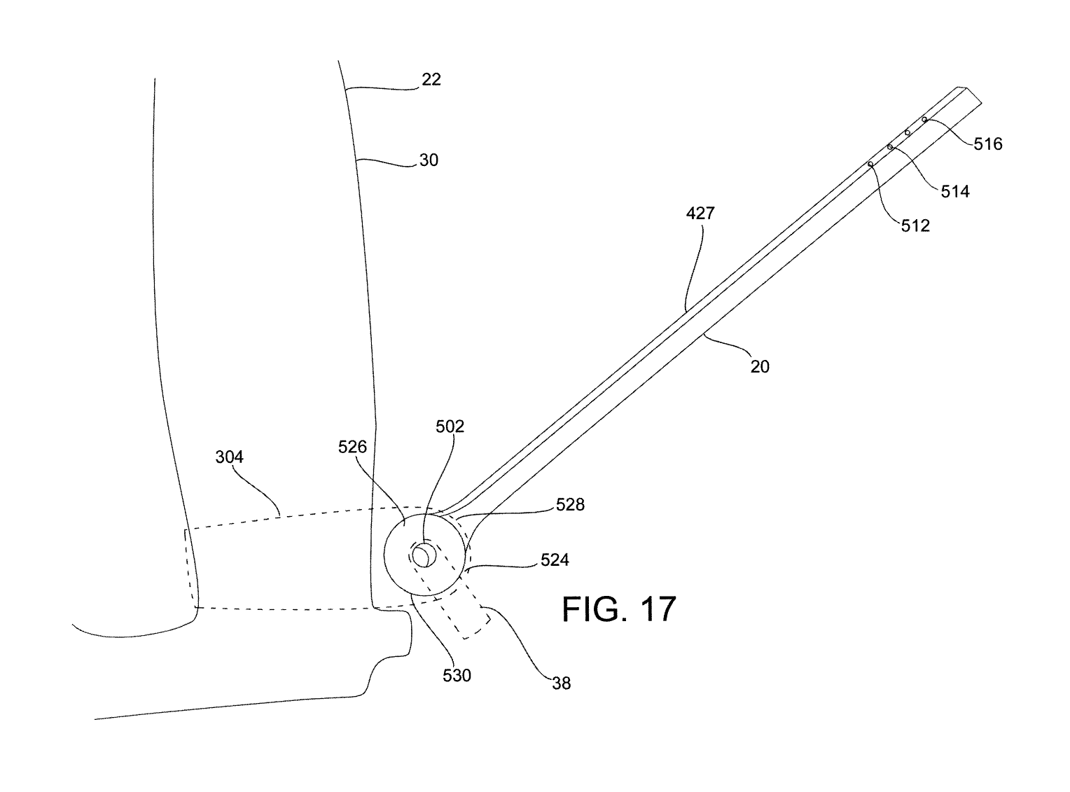

In the embodiment shown in FIGS. 16 and 17, the circumferential edge 532 is substantially co-centric with the pivot hole 502. This allows the forearm brace 20 to rotate through a vertical plane in a wider range than the embodiment shown in FIGS. 6 and 9 above and below a substantially horizontal position when the attachment mechanism, such as the quick release 38 of FIG. 11 (not shown in FIG. 16 for clarity) at least partially released. As shown in FIG. 16, the band engagement surface 526 includes a first end 528 and a second end 530. This band engagement surface 526 provides frictional resistance between the band 304 and the forearm brace 20 when the attachment mechanism 38 is sufficiently tensioned. This configuration allows the user to rotate the forearm brace vertically upwards without releasing the attachment mechanism, one the initial setting is achieved. It is conceived that this arrangement is particularly useful with lighter power tools, and where the handle 30 is angled away from the user at the top portion as the attachment device 524 can be adjusted to a wider range than other embodiments. This angulation can be seen in the handle 30 of FIG. 1 in comparison with the handle 30 of FIG. 17 which is much more vertical.

The embodiment shown in FIG. 16 differs from the embodiment shown in FIG. 17 in several respects; in one form, the support arm 426 includes a bend 510 as previously discussed in relation to FIG. 6, and the band engagement surface 526, has a somewhat teardrop shape when viewed from the side.

### Third embodiment

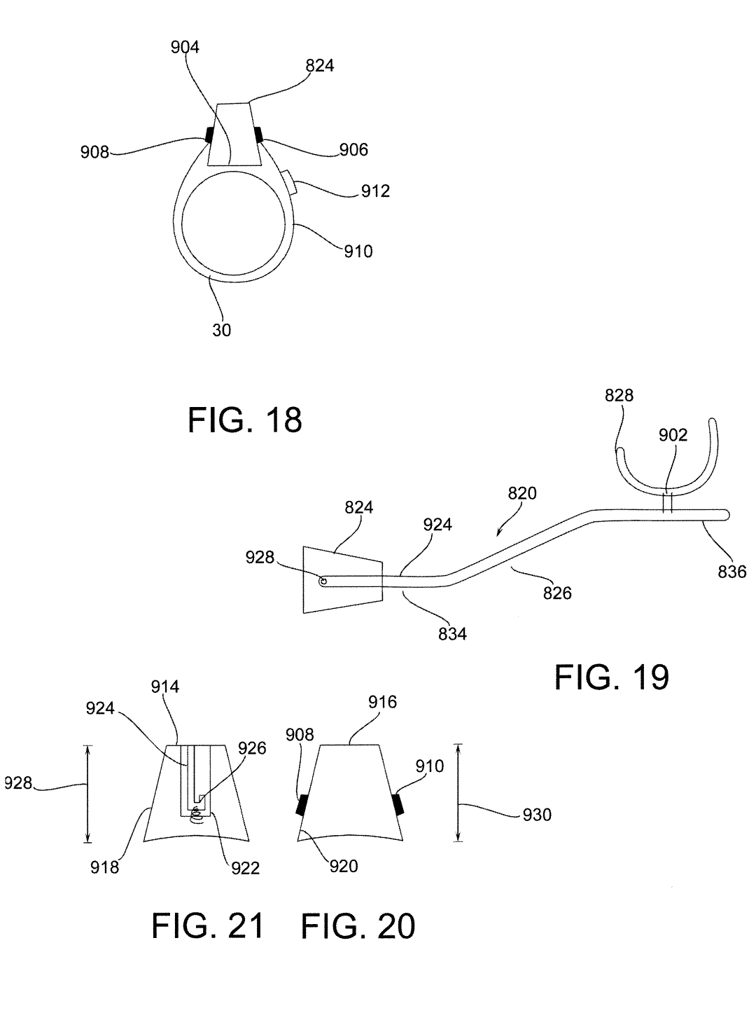

Another embodiment is shown in FIGS. 18 through 20 which utilizes a quick release support mechanism interoperating with the attachment device and the support arm.

This configuration generally consists of an attachment device 824 which is configured to wrap around, and therefore interconnect with the power tool handle 30, as shown in FIG. 18. Removeably attached to this attachment device 824 is a support arm 826 of FIG. 19 which operates similarly to the previously disclosed support arms.

Near the second end 836 of the support arm 826 is shown a pivot 902 which is configured to allow rotation of the forearm engagement surface in relation to the support arm 826. As shown in FIG. 19, the forearm engagement surface 828 is substantially rotated 90° from a normal operating orientation to more easily show how this embodiment can be arranged. The pivot 902 can be a quick release device, such as that shown in FIG. 11 and previously discussed, a simple wing nut and bolt combination, or other fastening means. The attachment device 824 and support arm 826 could also be connected to a forearm engagement surface of another embodiment. In one form, the pivot 902 is set within a channel or slot in the second end 836 of the support arm 826 to allow for longitudinal movement of the forearm engagement surface 828 for ease of use or comfort of the user.

This embodiment differs from the previously disclosed embodiments in that the attachment device 824 is configured to be easily separated from the support arm 826.

In one form, the attachment device 824 comprises a handle engagement surface 904 to fictionally engage the outer surface of the power tool handle 30 similar to previously disclosed embodiments. In one form, a plurality of fasteners 906 and 908 are disposed in either side of the attachment device 824 to couple to a tightening band 910. In another embodiment, the tightening band 910 wraps all the way around the attachment device 824. Once positioned around the power tool handle 30, a tensioning member 912 may be employed to increase the fictional connection between the handle engagement surface 904 and the outer surface of the power tool handle 30. Until sufficient friction is provided between these two members, the attachment device 824 is allowed to rotate through a horizontal plane around the power tool handle 30 this portion may function similar to a standard rack and worm screw hose clamp. These hose clamps are well known in the art, such as U.S. Pat. No. 2,680,892 and equivalents.

In one form, as shown in FIGS. 20 and 21, the attachment device 824 comprises an inner cylinder 914 and an outer sleeve 916. These cylinders work together to allow rotation of the support arm in relation to the tool handle until a desired orientation is achieved, at which point the orientation is substantially locked in place. The outer sleeve 916 has an inner surface 920 which substantially mates with the outer surface 918 of the inner cylinder 914. While these surfaces may be interoperating cones, they may also be polyhedrons or other shapes.

In one form, the inner cylinder 914 includes a surface defining a void 922 which has a surface substantially similar to the outer surface 924 of the first end 834 of the support arm 826, such that the first end 834 of the support arm 826 fits within the surface defining a void 922. This void 922 in one form also includes a keyway 924 with a locking keyway 926. This keyway 924 and the locking keyway 926 are configured to interoperate with an extrusion 928 provided in the first end 834 of the support arm 826 to maintain the support arm 826 within the surface defining a void 927.

In operation, the inner cylinder 914 is set within the outer sleeve 916 which provides a slight frictional engagement. The combination is then placed adjacent to the power tool handle 30, as shown in FIG. 18, the tightening band 910 is tensioned by way of the tensioning member 912 to secure the attachment device 824 in place against the handle engagement surface 904. The support arm 826 is then arranged such that the extrusion 928 aligns with the keyway 924 upon which the first end 834 is projected into the void 922 until the extrusion 928 can be aligned with the locking keyway 926. The support arm 826 is then rotated within the void 922 to lock in place. These types of arrangements are well-known in the art. Additional structures to maintain this locking position can be employed. If it is desired to reposition the inner cylinder 914 within the outer sleeve 916 at this point, the tensioning member 912 is released. In one form the length 928 of the inner cylinder 914 is slightly longer than the length 930 of the outer sleeve 916. Thus, when the tensioning member 912 is engaged, the outer surface 918 of the inner cylinder 914 is frictionally tensioned against the inner surface 920 of the outer sleeve 916 prohibiting substantial rotation or movement.

The support arm and forearm engagement surface can then be removed and replaced in the same orientation quickly and easily.

### Fourth Embodiment

The fourth environment, as shown in FIGS. 12 through 15, functions in a very similar manner to the third embodiment, as shown in FIGS. 18 through 21. This embodiment is configured to provide an attachment device 932 which can be quickly and easily attached and removed to the power tool 22. Furthermore, the attachment device 932 and support arm 826 are configured to interoperate in such a way that the first end 834 couples to the attachment device 932 to allow for rotation in a transverse plane generally perpendicular to the longitudinal axis of the first end 834 of the support arm 826. This allows for the forearm brace to be positioned in a plurality of positions for a user's comfort, and stability of the tool.

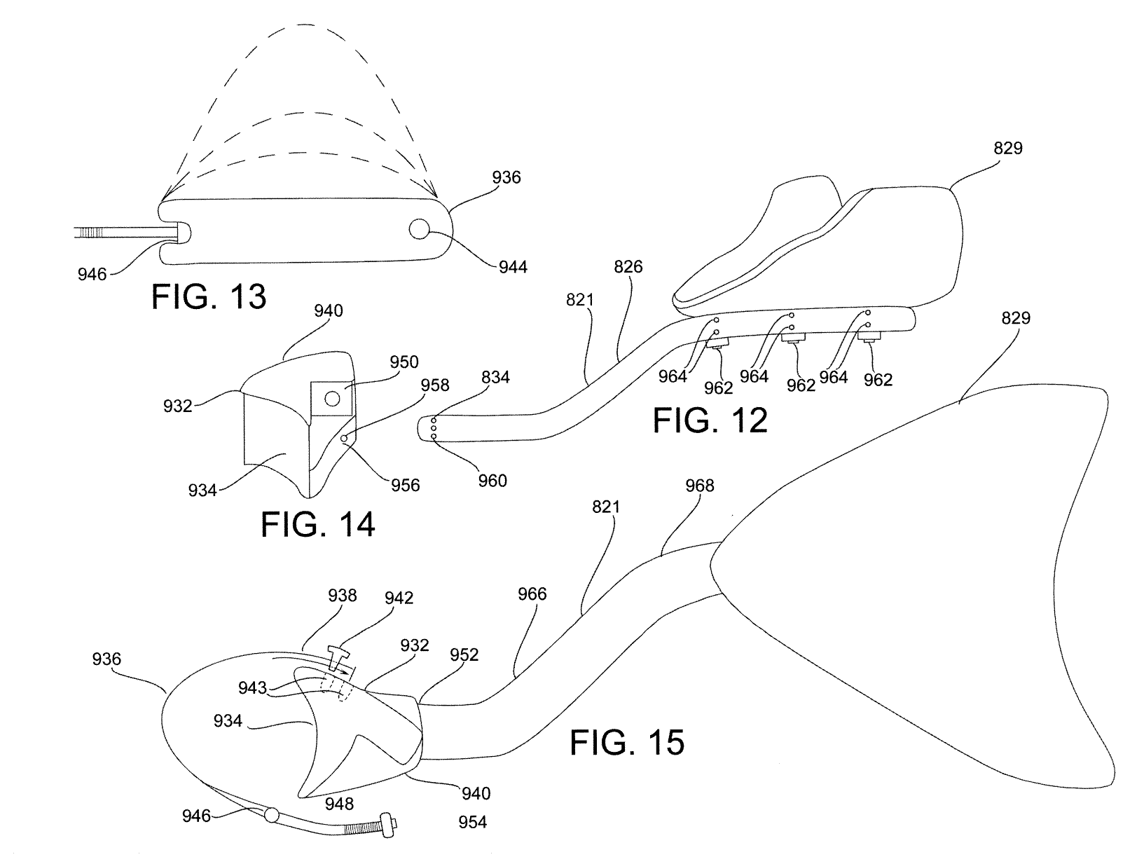

The construction of this embodiment is somewhat more complex than previous embodiments. The attachment device 932 in one embodiment includes a tool engagement surface 934 similar to previous embodiments. A band 936 is coupled at a first end 938 to the body 940 of the tool attachment device 934 by means of a fastener 942 into one of a plurality of holes 943. Shown as a thumb screw type device which passes through a hole 944 as shown in FIG. 13, the fastener 942 may then be threaded into a matching portion of the body 940 to maintain the band 936 and relative position. The band is then wrapped around a portion of the power tool 22 such as the power tool handle 30 in a manner as previously discussed. The opposite end of the band 936 may comprise a toggle 946 which is generally a T-shaped device which may end in a threaded portion 948. These toggles are well-known in the art and so will not be described in further detail herein. The threaded portion 948 passes through a hole 950 in the body 940. A nut 950 engages the threaded portion 948 to tension the band 936 which provides sufficient friction between the attachment device 932 and the power tool 22 to maintain relative position of the support arm 821 to the power tool 22. Of course, prior to engaging being that 950, the position of the attachment device 932 can be adjusted in the horizontal plane 18.

An attachment mechanism is shown in these Figs. which may also be used in conjunction with the embodiments previously discussed. In this environment, the attachment device body 940 includes a hole 952 which has a diameter slightly larger than the outer diameter of the first end 834 of the support arm 826. This allows the first end 834 to fit within the hole 952. A pin 956 can then be provided through a hole 958 and also through one of a plurality of holes 960 provided in the first end 834 of the support arm 826. Each of these holes are substantially perpendicular to the axis of the hole 952. This plurality of holes 960 allows for rotational positioning of the support arm 826 in relation to the attachment device 932. Of course, the pin 956 can be a split pin, bolt, rivet or any similar device.

To allow for rotational positioning of the forearm engagement surface 829 in relation to the attachment device 932, a plurality of attachments 962 may be provided which are configured to interoperate with the plurality of holes 964 in a similar manner to the plurality of holes 960. The attachments 962 function the same as the attachments 318, 320, 322, as shown in FIG. 2.

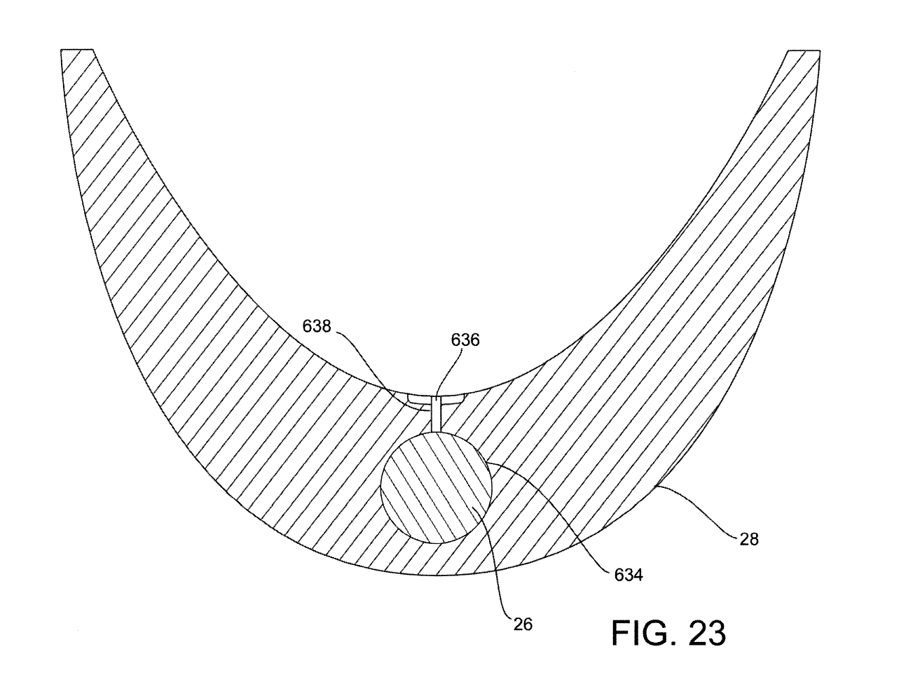

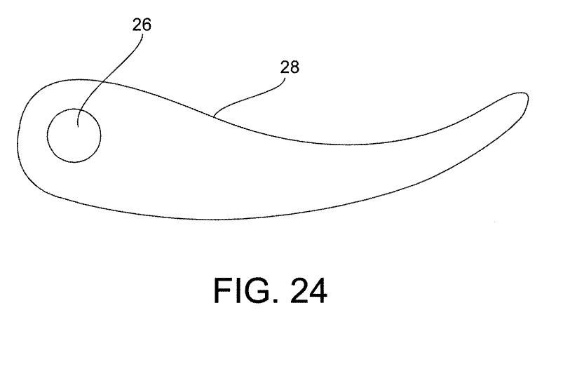

The forearm engagement surface 28 may also be attached to a support arm 26 via a sliding member 634 as shown in FIG. 23 and FIG. 24. In one form, the sliding member may be circular in cross section, allowing the forearm engagement surface 28 to pivot about the support arm 26 until a fastening system such as a set screw 636 is utilized. In one form, the set screw 636 is threaded into a void 638 in the forearm engagement surface 28 and through the sliding member 634. The sliding member may, in one form, be a simple longitudinal void, or may be a section of tubing or equivalent structure. When tightened, force is exerted upon the outer surface of the support arm 26, providing frictional resistance against movement about or along the support arm 26.

In another embodiment, a spring-loaded bullet catch may be utilized as the fastening system. For example, a bullet-catch-type device may be fitted to the forearm engagement surface on the interior of the sliding member 634. The bullet-catch would engage a recess in the support arm and maintain position relative to same. A user would apply sufficient force to remove or reposition the forearm engagement surface 28 relative to the support arm 26 when a different arrangement is desired.

While the embodiment of the support arm 826 shown in FIGS. 12,15, 23, 24 and others appears substantially round in cross-section, other geometries would also be effective. For example, faceted geometries such as a square, star, pentagon, octagon, etc. would allow for a more index able rotation of the apparatus and provide more rotational support.

In this embodiment, the support arm 826 includes a first bend 966 and a second bend 968. This allows the horizontal and vertical separation of the forearm engagement surface 829 in relation to the attachment device 932 to be preset to the desired arrangement of the user to conform to safety and/or comfort.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A forearm brace for a hand-held power tool, the forearm brace comprising:
a. a support arm removably coupled to the power tool at a first end of the support arm;
b. a forearm engagement surface disposed upon the second end of the support arm;
c. wherein the forearm engagement surface is operatively configured to engage a user's forearm between the user's radiocarpal joint and elbow such that rotation of the power tool in relation to the forearm of the user is substantially prohibited by upward force of the forearm engagement surface upon the user's forearm; and,
d. wherein the support arm is operatively configured to be removably coupled to the power tool by an attachment device which allows the support arm to pivot in relation to the power tool.

2. The forearm brace as recited in claim 1, wherein the attachment device is operatively configured to allow the support arm to pivot substantially at the first end of the support arm in a vertical plane in relation to the power tool.

3. The forearm brace as recited in claim 2, wherein the attachment device is operatively configured to allow the support arm to pivot substantially at the first end of the support arm in a vertical plane in relation to the power tool from 80° above a longitudinal axis of the power tool, to 80° below the longitudinal axis of the power tool.

4. The forearm brace as recited in claim 1, wherein the forearm engagement surface is a rigid structure extending from one or both transverse sides of the support arm.

5. The forearm brace as recited in claim 2, further comprising a spring mechanism operatively configured to rotate the support arm upward when pressure is not applied downward to the forearm engagement surface.

6. The forearm brace as recited in claim 1, wherein the attachment device is operatively configured to allow the support arm to pivot in a horizontal plane in relation to the power tool substantially at the first end of the support arm.

7. The forearm brace as recited in claim 6, wherein the forearm engagement surface is operatively configured to reposition about the support arm.

8. The forearm brace as recited in claim 1, wherein the forearm engagement surface further comprises a padded surface operatively configured to engage the user's forearm.

9. The forearm brace as recited in claim 8, wherein the padded surface comprises a gel pad.

10. The forearm brace as recited in claim 1, wherein the attachment device comprises a quick release mechanism operatively configured to adjust the position of the forearm brace in relation to the power tool.

11. The forearm brace as recited in claim 10, wherein the quick release mechanism is operatively configured to adjust the tension required to rotate the forearm brace in a horizontal or a vertical plane in relation to the power tool.

12. The forearm brace as recited in claim 1, wherein the forearm brace is operatively configured to be fixedly and removably coupled to the power tool.

13. The forearm brace as recited in claim 12, wherein the forearm brace is operatively configured to be coupled to the power tool without modification to the power tool.

14. The forearm brace as recited in claim 13, wherein the attachment device is operatively configured to couple to a handle portion of the power tool.

15. The forearm brace as recited in claim 14, wherein the attachment device does not substantially interfere with normal operation of the power tool handle portion.

16. The forearm brace as recited in claim 1, wherein the longitudinal length of the forearm brace is up to 13 inches from a tool engagement surface, to a longitudinally outward end.

17. The forearm brace as recited in claim 1, wherein the attachment device comprises a keyway operatively configured to receive a portion of the support arm.

18. The forearm brace as recited in claim 17, wherein the keyway further comprises a locking keyway operatively configured to maintain position of the support arm in relation to the attachment device while engaged.

19. The forearm brace as recited in claim 1, wherein the support arm, forearm engagement surface and/or attachment device are comprised of a unitary structure.

20. A forearm brace for a power tool, the forearm brace comprising:
a. a forearm engagement surface fixedly and removably coupled to the power tool,
b. wherein the forearm engagement surface is operatively configured to engage a user's forearm between the user's radiocarpal joint and elbow such that rotation of the power tool at the user's wrist is substantially prohibited by upward force of the forearm engagement surface upon the user's forearm, and
c. wherein the forearm engagement surface is operatively configured to be removably coupled to the power tool by an attachment device..

21. The forearm brace as recited in claim 20, wherein the attachment device is fixedly and removably coupled to the power tool, and the forearm engagement surface is fixedly and removably coupled to the attachment device.

22. The forearm brace as recited in claim 21, wherein the forearm engagement surface and attachment device are formed as a unitary structure.
